(19) United States
(12) Patent Application Publication
(10) Pub. No.: US 2010/0208971 A1
(43) Pub. Date: Aug. 19, 2010

(54) METHODS FOR IMAGING THE BLOOD PERFUSION

(75) Inventors: Christoph Neukirchen, Aachen (DE); Matthias Bertram, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/679,961

(22) PCT Filed: Sep. 24, 2008
(86) PCT No.: PCT/IB2008/053877

§ 371 Date: Mar. 25, 2010

(30) Foreign Application Priority Data
Sep. 27, 2007 (EP) 07117426.2

(51) Int. Cl. G06K 9/00

(52) U.S. Cl. 382/132

(57) ABSTRACT

It is provided a method for imaging a dynamic process in a part of the body, especially blood perfusion, with an x-ray system as well as corresponding apparatuses and a corresponding computer readable medium. Especially it is described a method for imaging a dynamic process in a part of the body, especially blood perfusion, with an x-ray system, comprising: acquiring rotational projections of the part of the body over an angular range (2), deriving the anatomy of the part of the body subject to the dynamic process using a tomographic reconstruction from the projections (3), determining an optimal position of the x-ray system according to the derived anatomy for acquiring projections of the dynamic process (4), administering contrast agent to the part of the body (5), acquiring projections of the dynamic process from the determined position (6); calculating the dynamic contrast enhancement over time (7); and calculating and displaying perfusion parameters (8).

### FIELD OF THE INVENTION

The invention relates to methods as well as corresponding apparatuses or computer readable media for imaging dynamic processes, especially blood perfusion in a human or animal body.

### BACKGROUND OF THE INVENTION

During x-ray guided interventions, knowledge of blood perfusion in soft tissue is of exceptional interest in several clinical applications for purposes of outcome control and planning support. Blood perfusion imaging can be realized by tracking over time the spatial distribution of x-ray-opaque contrast agent that is administered to the patient. Such tracking information in the patient's tissue capillaries can be derived from projection information acquired with dynamic x-ray detector systems mounted on the interventional device. For pure diagnostic purposes, a particular instance of such method (based on repeated application of tomographic reconstruction methods in a series of rotations) is used with a fast rotating CT system that is mounted in a closed gantry.

The document WO 2006/003578 A1 shows an examination apparatus and a method for perfusion studies in a patient. According to this disclosure, a rotational x-ray device is moved on a trajectory while continuously generating projections of the patient after the injection of a contrast agent with an injection device. The projections are used by a data processing system in a sliding window technique to reconstruct three-dimensional images of the body volume. The resulting sequence of 3D images may be displayed on a monitor to reveal the desired information about the perfusion process.

In contrast to standard CT systems, the x-ray imaging system typically used for interventions is mounted on an open c-arm device that has limited rotational capabilities in terms of speed and movement range. Due to the mechanical construction, today's c-arm devices are merely capable to perform the so called “short scan” movement during projection acquisition which resembles slightly more than a half circle rotation (180 degrees plus fan angle of the x-ray beam, typically within a plane perpendicular to the patient table) in a time interval of several seconds. Caused by these mechanical limitations, the repeated tomographic reconstruction approach (as used in diagnostic CT-perfusion systems) cannot be applied straightforward for fully spatially resolved perfusion imaging using c-arm systems.

For non-fully spatially resolved imaging of blood perfusion, the c-arm may remain at a fixed position during dynamic acquisition of planar x-ray projections. From projections acquired at a fixed position, spatial information can only be derived for a surface area perpendicular to the direction of the x-rays; all “depth information” along the direction of the x-rays is naturally lost.

Perfusion imaging using interventional x-ray devices would be highly desired, offering significantly improved workflow for many x-ray guided interventional procedures. However, fully spatially resolved quantitative perfusion imaging requires fast or continuous rotation modes, which are beyond the capabilities of current C-arm systems.

### SUMMARY OF THE INVENTION

It is an object of the present invention to provide a method for imaging a dynamic process in a part of the body, especially blood perfusion, with an x-ray system as well as corresponding apparatuses and a corresponding computer readable medium.

This object is achieved by the independent claims. Preferred embodiments are disclosed in the dependent claims.

According to an aspect of the present invention, the above object may be achieved by a method as set forth in claim 1, where imaging of a dynamic process in a part of the body, especially blood perfusion, with an x-ray system is provided, comprising: acquiring rotational projections of the part of the body over an angular range, deriving the anatomy of the part of the body subject to the dynamic process using a tomographic reconstruction from the projections, determining an optimal position of the x-ray system according to the derived anatomy for acquiring projections of the dynamic process, administering contrast agent to the part of the body, acquiring projections of the dynamic process from the determined position; calculating the dynamic contrast enhancement over time; and calculating and displaying perfusion parameters.

According to another exemplary embodiment of the present invention the derivation of the anatomy of the part of the body is achieved by means of manual or automatic segmentation.

According to a further exemplary embodiment of the present invention the calculation of the dynamic contrast enhancement over time is achieved by using scaling factors to normalize the dynamic contrast attenuation along x-ray directions in the determined position, and whereas the scaling factors are derived from the anatomy of the part of the body.

According to a further exemplary embodiment of the present invention an open c-arm x-ray system is used.

According to another exemplary embodiment of the present invention a method for imaging a dynamic process of a part of a body, especially blood perfusion, is provided with an x-ray system, comprising: administering contrast agent to the part of the body, acquiring rotational projections of the dynamic process over time of the part of the body over an angular range, deriving the anatomy of the part of the body subject to the dynamic process using tomographic reconstruction from the projections, calculating scaling factors from the derived anatomy for proper normalization of contrast attenuation along x-ray directions, calculating the dynamic process from the projections using the scaling factors; calculating and displaying perfusion parameters.

According to another exemplary embodiment calculating the dynamic process from the projections involves subtracting the static projection data mask that is derived from the tomographic reconstruction from the projections.

According to a further exemplary embodiment of the present invention calculating the dynamic process from the projections involves subtracting a projection data mask derived from another tomographic reconstruction from another run of acquired projections.

According to another exemplary embodiment an open c-arm x-ray system is used.

According to a further exemplary embodiment of the present invention a computer readable medium encoded with a computer program configured to execute one of the methods according to claims 1 to 8.

According to another exemplary embodiment of the present invention an apparatus is adapted to execute one of the methods according to claims 1 to 8.

### BRIEF DESCRIPTION OF THE DRAWINGS

In the following the invention is described by way of example with the help of the accompanying drawings in which:

FIG. 1 shows a flow-chart of an exemplary embodiment of the present invention,

FIG. 2 shows a flow-chart of another exemplary embodiment of the present invention,

FIG. 3 shows a computer system

### DESCRIPTION OF PREFERRED EMBODIMENTS

It is advantageous to keep the c-arm mounted imager fixed during dynamic acquisition at a convenient (angular) position such that the unavoidable information loss in depth direction is minimized. However, it is difficult to guess the optimal c-arm positioning without having good knowledge about the anatomy of the patient region of interest.

When analysing (by inspecting planar dynamic projection data) the temporal attenuation enhancement induced by distribution of the contrast agent, the average spatial contrast density along the direction of x-rays may be of clinical interest. However, even such directionally averaged information on contrast distribution is unavailable since the length of contrast agent distribution along x-ray direction is not known.

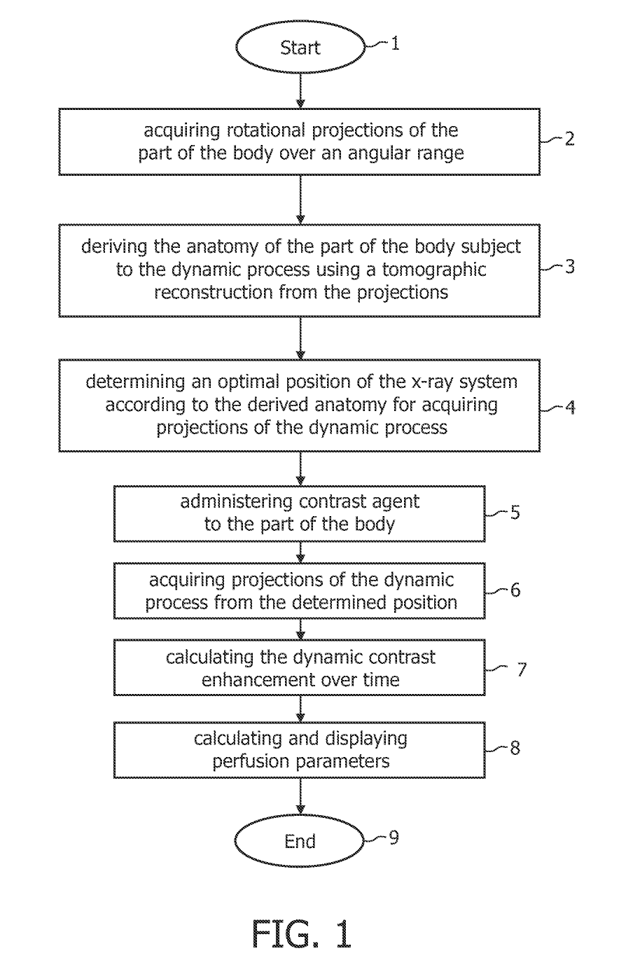

FIG. 1 shows an exemplary embodiment of the present invention, whereas the flow-chart has a start 1. The flow-chart depicts an exemplary method of the present invention for imaging a dynamic process in a part of the body, especially blood perfusion, with an x-ray system, comprising: acquiring rotational projections of the part of the body over an angular range 2, deriving the anatomy of the part of the body subject to the dynamic process using a tomographic reconstruction from the projections 3, determining a optimal position of the x-ray system according to the derived anatomy for acquiring projections of the dynamic process 4, administering contrast agent to the part of the body 5, acquiring projections of the dynamic process from the determined position 6; calculating the dynamic contrast enhancement over time 7; and calculating and displaying perfusion parameters 8. The flow-chart has an end 9.

This exemplary method is based on a two-scan protocol. After (optional) contrast injection, a standard rotational soft-tissue run is used to derive the 3D anatomy of the perfused part of the body, especially tissue region (vascular territory, i.e., tissue excluding bones, air regions etc.), by means of manual or automatic segmentation. Based on this information, an optimal projection angle, e.g. maximizing the projected perfused area, is chosen. A contrasted perfusion sequence is then acquired from the chosen fixed projection angle, and for quantitative analysis each line integral is normalized by the corresponding intersection length with the segmented perfused area.

Therefore, at first, a standard short-scan rotational soft tissue run (without administration of contrast agent) is performed in order to compute scaling factors for proper normalization of contrast attenuation along x-ray directions and to determine the optimal fixed c-arm position for dynamic projection acquisition.

Then, the c-arm is positioned and fixed at the determined optimal position. A bolus of contrast agent is administered (intra-arterial for optimal enhancement) while dynamic projections are acquired for the final analysis of the blood perfusion.

Such two-step acquisition mode has the advantage to provide perfusion image information that is properly normalized (i.e. averaged) along the “depth direction” and fully spatially resolved in the plane parallel to the x-ray detector.

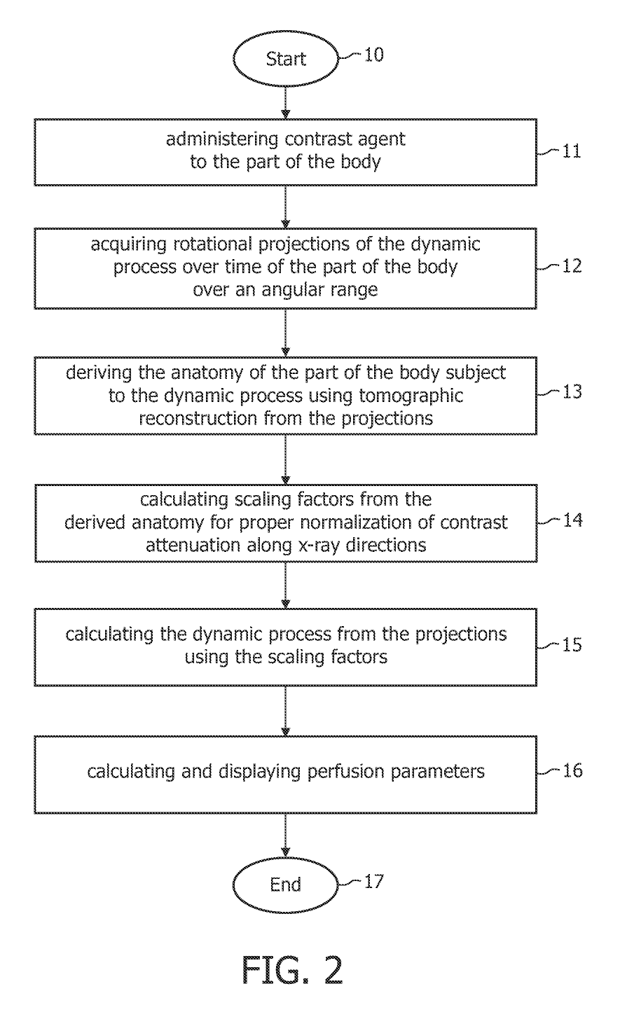

FIG. 2 shows a flow-chart, which has a start 10. The flow-chart depicts an exemplary method of the present invention for imaging a dynamic process of a part of a body, especially blood perfusion, with an x-ray system, comprising: administering contrast agent to the part of the body 11, acquiring rotational projections of the dynamic process over time of the part of the body over an angular range 12, deriving the anatomy of the part of the body subject to the dynamic process using tomographic reconstruction from the projections 13, calculating scaling factors from the derived anatomy for proper normalization of contrast attenuation along x-ray directions 14, calculating the dynamic process from the projections using the scaling factors 15; calculating and displaying perfusion parameters 16. The flow-chart has an end 17.

Another exemplary embodiment of the present invention is based on an even simpler acquisition, employing only a single, contrasted rotational run. From the static tomographic reconstruction, the total perfused volume is estimated as in the first method. Then, each line integral in each projection is normalized by the corresponding intersection length with the perfused area. A global (non-spatially resolved) value for blood perfusion in each time step can be obtained by spatially averaging the normalized line integrals in each projection, thus resulting in the global average density of contrast material over time, which can be used as a coarse quantitative measure for blood perfusion.

Therefore, a single short-scan rotational soft tissue run is carried out by the c-arm system during simultaneous injection of contrast agent. In a first processing step, scaling factors are computed for proper normalization of contrast attenuation along all x-ray directions that are covered during the rotational run. In a second processing step, a global (non-spatially resolved) measure of blood perfusion is computed from the projections of the rotational run. This one-step acquisition mode provides a “correctly normalized” global perfusion measure (i.e. non-spatially resolved) utilizing a single rotational system run for projection acquisition.

Therefore, the invention aims at providing means for perfusion imaging at a restricted level of spatial resolution (but sufficient for certain applications) in spite of the limitations of today's c-arm systems regarding range and speed of movement during projection acquisition. This is realized by using a certain order of projection acquisition runs (with and without administration of contrast agent; short-scan rotational and non-rotational at fixed position) and intermediate image processing and tomographic reconstruction steps.

The projection acquisition and image processing steps that must be carried according to exemplary embodiments of the invention: Based on the acquired projections from the non-contrasted rotational short-scan, a volume image is reconstructed tomographically. The 3-dimensional part of the body, especially soft-tissue organ area, which is subject to blood perfusion is determined utilizing an appropriate method for 3-D volume segmentation. Based on the segmented tissue, the optimal x-ray source position for dynamic (i.e. contrasted) projection imaging is calculated: one possible criterion of the “optimal” viewing position the maximization of the size of the projected area of the segmented organ; such criterion minimizes the loss of depth information along the direction of the x-rays. Given such optimal viewing position and given the c-arm system's geometry, the “effective length” of contrast material along each x-ray can be computed from the length of the intersection of that ray with the segmented organ in the 3-D volume.

Based on the dynamic acquisition of projections from the optimal fixed position while injecting contrast material, a projection sequence that resembles line integrals (along x-ray directions) of contrast material only is generated by subtraction of a corresponding (wrt. the viewing position) non-contrasted projection (i.e. a DSA mask) acquired in the first rotational run. Finally, the computed “effective lengths” are used as normalization factors that scale the line integrals of contrast material in order to end up with a blood perfusion parameter for the averaged density of contrast agent along each ray. This averaged contrast density information is available for each point in the plane parallel to the detector plane for the given viewing position.

A volume image is generated tomographically by using a standard static reconstruction method that makes use of the dynamic projections acquired in the contrasted rotational short-scan run. Here, injection of the contrast medium and the duration of c-arm rotation have to be synchronized such that the first-pass circulation of contrast is completely covered by the acquisition interval of the rotational imaging system. Due to the influence of non-static and inconsistent contrast material in the different projections, the image quality of the reconstructed volume is harmed by artefacts to a certain degree. Even though these artefacts typically result in loss of certain details in the reconstructed volume, a coarse 3-D segmentation operation (as described above) can be used to tag those organ regions in the patient volume (parts of the body) that resemble soft tissue subject to perfusion.

To obtain “line integrals of contrast material” along the x-ray directions for each viewing position during the rotational run, a DSA-like subtraction mask is generated from the reconstructed volume containing the segmented parts of the body, especially soft tissue organs,: The line integrals of the static reconstructed volume that is modified by “cutting out” the regions segmented as perfused parts of the body, especially soft-tissue organs, are computed along the directions of x-rays for all viewing positions corresponding to those of the rotational acquisition run. These “static line integrals” are used as DSA-mask for the projections of the contrasted rotational run.

As described above for the two-step acquisition mode, the computed “line integrals of contrast material” are normalized by their “effective line lengths” to generate values of average density of contrast material. The proper normalization scaling is computed in the same way as described above by determination of length of intersections of the x-rays with the segmented parts of the body, especially soft-tissue organs. This finally results in a temporal sequence of averaged contrast medium densities which is spatially resolved in the plan parallel to the detector which rotates continuously according to temporal variation of viewing positions.

A global (non-spatially resolved) value for blood perfusion in each time step can be obtained by spatially averaging the normalized line integrals in the plane parallel to the corresponding detector position. This in-detector-plane averaging can be performed for each time step resulting in a temporal sequence of one single parameter describing the global average density of contrast material over time, yielding a coarse measure for blood perfusion.

The described acquisition modes for imaging of blood perfusion via injection of contrast material can be applied on any interventional x-ray c-arm system that is capable of a standard short-scan rotational acquisition (e.g. the Philips Allura Xper FD20 system). Perfusion imaging during interventions is of particular interest in the fields on treatment planning and outcome control. Typical application fields in the Cathlab are carotid artery stenting, acute stroke treatment, tumour visualization and embolization, treatment of peripheral vascular diseases, etc.

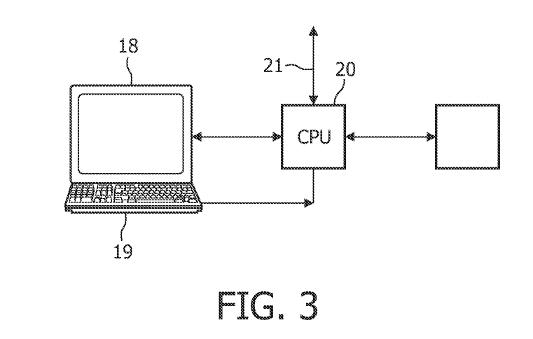

FIG. 3 shows a computer system with a computer readable medium encoded with a computer program configured to execute one of the methods according to claims 1 to 8. There is illustrated a computer 18 with a keyboard 19, whereas the computer 18 comprises a CPU 20, which enables interfaces e.g. 21.

It is provided a method for imaging a dynamic process in a part of the body, especially blood perfusion, with an x-ray system as well as corresponding apparatuses and a corresponding computer readable medium. Especially it is described a method for imaging a dynamic process in a part of the body, especially blood perfusion, with an x-ray system, comprising: acquiring rotational projections of the part of the body over an angular range (2), deriving the anatomy of the part of the body subject to the dynamic process using a tomographic reconstruction from the projections (3), determining an optimal position of the x-ray system according to the derived anatomy for acquiring projections of the dynamic process (4), administering contrast agent to the part of the body (5), acquiring projections of the dynamic process from the determined position (6); calculating the dynamic contrast enhancement over time (7); and calculating and displaying perfusion parameters (8).

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosures, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the internet or other wired or wireless telecommunication systems. Any reference signs in the claims should not be construed as limiting the scope.

1. A method for imaging a dynamic process in a part of the body, especially blood perfusion, with an x-ray system, comprising:
acquiring rotational projections of the part of the body over an angular range (2),
deriving the anatomy of the part of the body subject to the dynamic process using a tomographic reconstruction from the projections (3),
determining an optimal position of the x-ray system according to the derived anatomy for acquiring projections of the dynamic process (4),
administering contrast agent to the part of the body (5),
acquiring projections of the dynamic process from the determined position (6);
calculating the dynamic contrast enhancement over time (7); and
calculating and displaying perfusion parameters (8).

2. The method according to claim 1, wherein the deriving of the anatomy of the part of the body is achieved by means of manual or automatic segmentation.

3. The method according to claim 1 wherein the calculation of the dynamic contrast enhancement over time is achieved by using scaling factors to normalize the dynamic contrast attenuation along x-ray directions in the determined position, and wherein the scaling factors are derived from the anatomy of the part of the body.

4. The method according to claim 1, wherein an open c-arm x-ray system is used.

5. A method for imaging a dynamic process of a part of a body, especially blood perfusion, with an x-ray system, comprising:
administering contrast agent to the part of the body (11),
acquiring rotational projections of the dynamic process over time of the part of the body over an angular range (12),
deriving the anatomy of the part of the body subject to the dynamic process using tomographic reconstruction from the projections (13),
calculating scaling factors from the derived anatomy for proper normalization of contrast attenuation along x-ray directions (14),
calculating the dynamic process from the projections using the scaling factors (15); and
calculating and displaying perfusion parameters (16).

6. The method according to claim 5, wherein calculating the dynamic process from the projections involves subtracting the static projection data mask that is derived from the tomographic reconstruction from the projections.

7. The method according to claim 5, wherein calculating the dynamic process from the projections involves subtracting a projection data mask derived from another tomographic reconstruction from another run of acquired projections.

8. The method according to claim 5, wherein an open c-arm x-ray system is used.

9. A computer readable medium encoded with a computer program configured to execute one of the methods according to claim 1.

10. An apparatus adapted to execute one of the methods according to claim 1.
